(19) United States
(12) Patent Application Publication
(10) Pub. No.: US 2002/0140797 A1
(43) Pub. Date: Oct. 3, 2002

(54) Take-up and release mechanism for a printer

(76) Inventor: Dane Watkins, Evanston, IL (US)

Correspondence Address: Trexler, Bushnell, Giangiorgi,, Blackstone & Marr, Ltd., 36th Fl., 105 West Adams Street, Chicago, IL, 60603, US

(21) Appl. No.: 10/106,609

(22) Filed: Mar. 26, 2002

Related U.S. Application Data
(60) Provisional application No. 60/279,186, filed on Mar. 27, 2001.

(51) Int. Cl. B41J 2/01

(52) U.S. Cl. 347/105

(57) ABSTRACT

A media take-up and release mechanism includes a spindle and a fin. A ramp is provided on the exterior of the spindle. A fin engages the ramp on the spindle. Backing is collected by winding the backing around the take-up spindle assembly. To remove a roll of backing from the take-up spindle assembly, the effective diameter of the take-up spindle assembly is reduced by sliding the fin along the ramp. With the effective diameter of the take-up spindle assembly reduced, the backing slides easily over and off of the take-up spindle assembly.

### RELATED APPLICATIONS

This application claims the priority of U.S. provisional application Serial No. 60/279,186 filed on Mar. 27, 2001 and entitled “Liner Take-Up Spindle For A Printer”.

### BACKGROUND OF THE INVENTION

A mechanism for a printer is provided which collects a backing and removes the backing from a take-up spindle. For example, the mechanism can be used in connection with a printer which includes a peel assembly.

Printers having peel assemblies are used to print on labels which are attached to a backing. After printing, the labels are peeled from the backing using a peel mechanism. After peeling, the backing is collected and disposed of. Sometimes, the backing is simply allowed to exit the printing and peeling assembly where it is then collected and disposed of. Alternatively, the backing is wound on a take-up spindle. Once the take-up spindle is full, the backing is removed from the spindle and disposed of.

In prior art printer, a take-up spindle is used to collect the backing, the diameter of the take-up spindle is often small and the backing has a tendency to unwrap as the first windings are made around the take-up spindle. Also, in a prior art printer, when a take-up spindle is used to collect the backing, the inner windings of the backing become tightly wound around the take-up spindle and it is difficult to remove the backing from the take-up spindle. In addition to the windings being tightly wound around the take-up spindle, the windings are often positioned close to a back plate against which the take-up spindle sits making it difficult for a users to place his fingers behind the windings to assist in removing the backing from the take-up spindle.

### OBJECTS AND SUMMARY OF THE INVENTION

A general object of the present invention is to provide a mechanism for a printer which collects backing on the mechanism.

Another object of the present invention is to provide a mechanism for a printer which prevents the windings of backing from slipping off of the mechanism.

Yet another object of the present invention is to provide a mechanism for a printer which includes features which allows windings of a backing to be easily removed from around the mechanism.

Briefly, and in accordance with the foregoing, a media take-up and release mechanism includes a take-up spindle mounted to a printer. The take-up spindle is used to collect windings of the backing. A fin is engaged with the take-up spindle. A ramp is provided on the exterior surface of the take-up spindle and fingers extend from the take-up spindle on either side of the ramp. An inner surface of the fin is sloped at an angle which corresponds with the angle of the ramp. A locking protrusion extends from the inner surface of the fin and is capable of sliding along the ramp. The locking protrusion is positioned between the fingers and engages the fin with the spindle. A spring provides biasing between the fin and the back plate. Winding of the backing begins by placing the backing through a slit in the spindle. The backing is then wound around the perimeter of the spindle and the fin. When the backing is to be released, the user grasps the fin and pulls the fin away from the backplate, causing the spring to extend. As the spring is pulled away from the backplate, the fin slides along the ramp causing the effective diameter around which the inner windings of the backing are wound to decrease. Because the effective diameter around which the inner windings are wound is decreased, a space is provided between the take-up spindle and fin and the inner windings and therefore the backing can be easily removed from the take-up spindle.

### BRIEF DESCRIPTION OF THE DRAWINGS

The organization and manner of the structure and operation of the invention, together with further objects and advantages thereof may best be understood by reference to the following description, taken in connection with the accompanying drawings, wherein like reference numerals identify like elements in which:

FIG. 1 is a perspective view of a printer which includes a take-up and release mechanism which incorporates the features of the invention;

FIG. 2 is partial cross-sectional view of the printer showing the take-up and release mechanism;

FIG. 3 is an exploded perspective view of the take-up and release mechanism;

FIG. 4 is a side elevational view of the take-up and release mechanism showing a portion of the mechanism broken away; and

FIG. 5 is a cross-sectional view of the take-up and release mechanism along a line 5-5 of FIG. 4.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

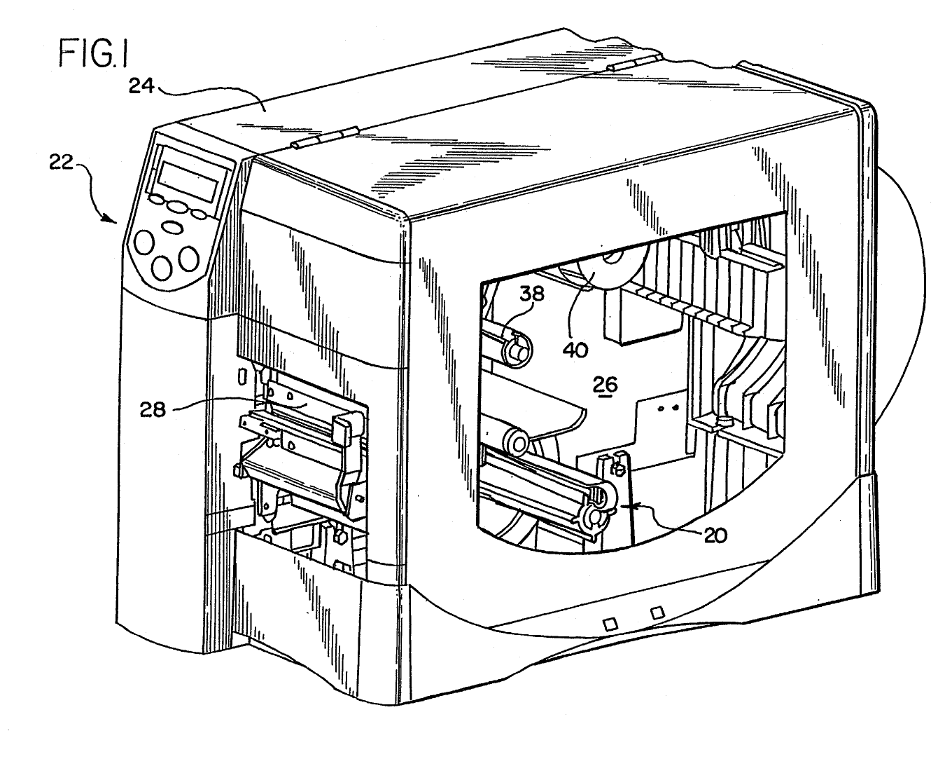

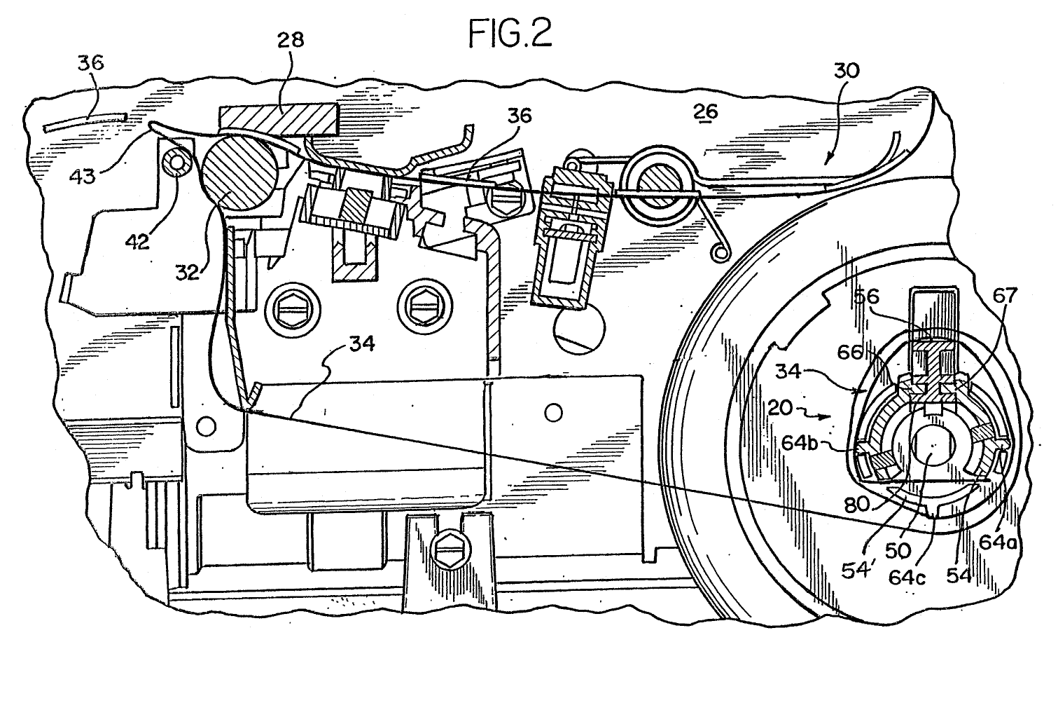

A take-up and release mechanism 20 is provided for a printer 22. The mechanism 20 can be used in connection with a variety of devices in which a continuous medium is to be collected. The mechanism 20 is shown in FIGS. 1 and 2 in connection with a thermal demand printer 22, but it is to be understood that the present invention can be used on other types of printers. The mechanism 20 is shown in connection with media 30, which is formed from a continuous backing 34 (also known as a liner or a web) having a plurality of labels 36 releasably secured thereto. The labels 36 are releasably secured to the backing 34 by a releasable adhesive. The labels 36 are spaced apart from each other on the backing 34. Although the mechanism is shown in connection with media 30, it is to be understood that the present invention can be used in connection with a variety of medium types, such as, for example, tape or film.

The printer 22 has a housing 24 which houses various operating components. The housing 24 has a plurality of ports, serial and/or parallel, thereon for connection to external devices, such as a CPU and a monitor, a plug for connection of a power source thereto, and an on/off switch for turning the printer 22 on or off. Ventilation apertures are provided on the housing 24. A central support wall 26 is provided within the housing 24 and extends perpendicularly from a bottom wall of the housing 24 and is secured thereto.

As shown in FIGS. 1 and 2, conventional ribbon delivery means is provided for delivering a ribbon (not shown) to a printhead means 28. Labels 36 are printed on by using the ribbon. The ribbon delivery means generally includes a ribbon supply spindle 38 and a ribbon take-up spindle 40. The ribbon supply spindle 38 is cantilevered from the central support wall 26 such that the ribbon supply spindle 38 extends outwardly and perpendicularly therefrom. The ribbon supply spindle 38 is rotatable relative to the central support wall 26. Suitable conventional driving means (not shown) are provided for driving the ribbon supply spindle 38.

The ribbon take-up spindle 40 is cantilevered from the central support wall 26 such that the ribbon take-up spindle 40 extends outwardly and perpendicularly therefrom. The ribbon take-up spindle 40 is rotatable relative to the central support wall 26. Suitable conventional driving means (not shown) are provided for driving the ribbon take-up spindle 40. The ribbon take-up spindle 40 is spaced apart from the ribbon supply spindle 38 on the central support wall 26.

FIG. 2 shows some of the internal components of the printer 22 on one side of the central support wall 26. Electronics are also provided within the printer 22 and may be on the other side of the central support wall 26.

A conventional printhead assembly 28 is provided and includes a conventional printhead support and conventional printhead means fixedly attached thereto. The printhead means is comprised of an array of heating elements which are selectively energized. Energizing selected heating elements of the array produces a single line of a printed image by heating the ribbon, or some other member. While ribbon is described herein, it is to be understood that these other types of members are suitable, along with other types of member known in the art. The ribbon is a thermally activated ribbon which transfers ink onto the labels when the printhead means is thermally activated by suitable electronics. Complete images are printed by repeatedly energizing varying patterns of the heating elements while moving media 30 past the printhead means. Power to the printhead means is supplied by a power source which is wired thereto by a cable which passes from the power supply through the central support wall 26.

Conventional media delivery means is provided for delivering the media 30 to the printhead means. The media delivery means includes a conventional positively-driven platen roller 32. The media 30 is fed into the printer 22 from a roll provided on a media supply spindle (not shown) within the printer 22 or from a source outside of the printer 22.

The platen roller 32 is cylindrical and typically rubber coated and extends perpendicularly outwardly from the central support wall 26 and is rotatably mounted thereto. The platen roller 32 has a shaft that extends through the central support wall 26 and connects with a driving system (not shown).

The take-up and release mechanism 20 allows a user of the printer 22 to roll up and dispose spent backing 34 (the backing 34 after the labels 36 have been peeled therefrom) during operation of the printer 22. The take-up and release mechanism 20 is compact and fits into a standard printer.

As shown, the take-up and release mechanism 20 works with a peel mechanism 42 in which bending the backing 34 around the tight radius 43 peels the labels 36 from the backing 34 and which when the backing 34 exits the peel mechanism 42. The spent backing 34 is wound up on the media take-up and release mechanism 20 after the backing 34 exits the peel mechanism 42. If the take-up and release mechanism 20 were not used in the printer 22, when the backing 34 exits the peel mechanism 42, the backing 34 would simply drop to the floor of the printer 22 or users would have to purchase a deep base for rewind capability.

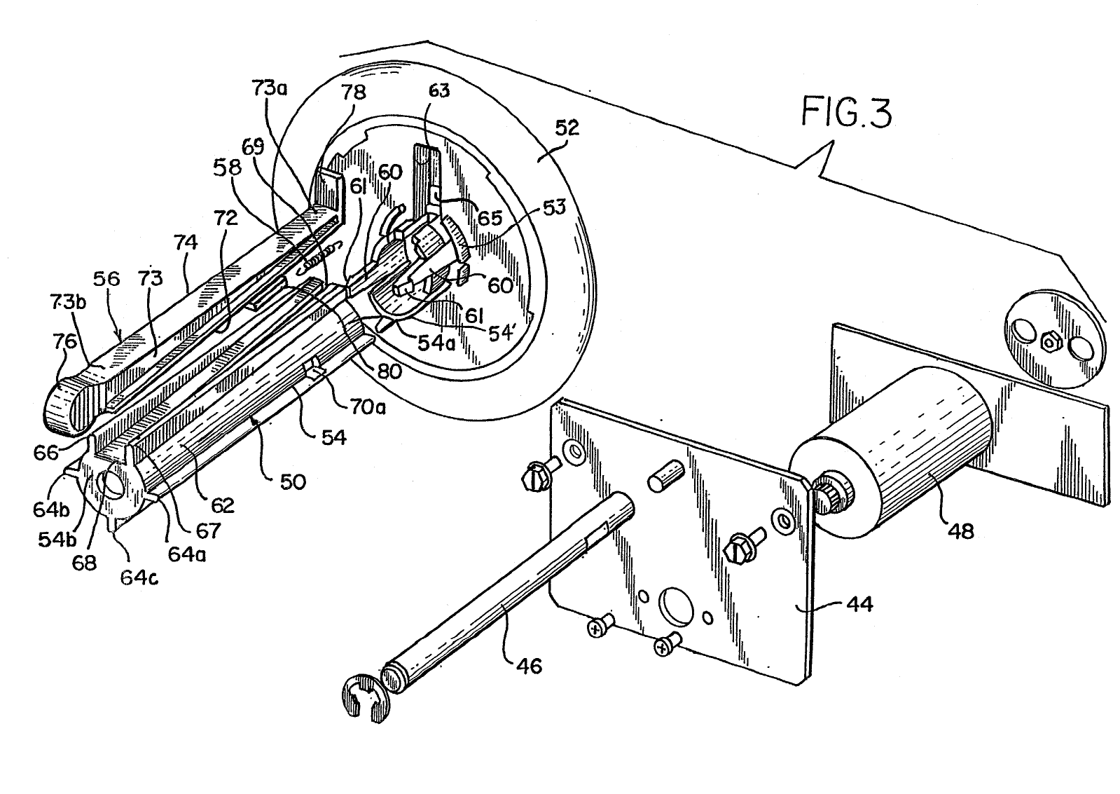

As best shown in FIG. 3, the take-up and release mechanism 20 includes a mounting bracket 44 which is suitably mounted on the central support wall 26, a shaft 46 and a motor 48 that are mounted on the mounting bracket 44, and a take-up spindle assembly 50 that slides onto the shaft 46. The motor 48 drives the take-up spindle assembly 50 mounted thereon. The spindle assembly 50 is driven by the motor 48 through gearing, and at the same rate of rotation as that which the platen roller 32 is driven. As a result, the take-up and release mechanism 20 does not contribute to the peeling of the labels 36 from the liner 34.

The take-up spindle assembly 50 includes a plastic back plate 52, a plastic spindle 54, a plastic fin 56, and an extension spring 58. The spent backing 34 is wound on the take-up spindle assembly 50.

The back plate 52 includes a pair of arms 60 which extend therefrom. The arms 60 are spaced apart from each other, but are linearly aligned with each other. An ear 61 is provided at the end of each arm 60 and extends outwardly therefrom. A rectangular-shaped recess 63 is provided in the back plate 52. An aperture 65 is provided through the backplate 52 within the recess 63 for reasons described herein. Curved walls 53 extend perpendicularly from the back plate 52 proximate the arms 60.

The spindle 54 includes a fixed end 54a which will be mounted to the back plate 52 as will be described herein and a free end 54b. The spindle 54 has a generally cylindrical base 62 with a plurality of elongated spindle ribs 64a, 64b, 64c which extend from the exterior surface of the base 62. As shown in FIG. 3, the spindle rib 64a is positioned at the zero degree point, the spindle rib 64b is positioned at the one hundred and eighty degree point, and the spindle rib 64c is positioned at the two hundred and seventy degree point (these spindle rib 64a, 64b, 64c positions will move as the spindle 54 rotates). Each of the ribs 64a, 64b, 64c extend along the entire length of the spindle 54.

As shown in FIG. 3, near the ninety degree point, two elongated fingers 66, 67 are provided which extend from the exterior surface of the base 62 (these finger 66, 67 positions will move as the spindle 54 rotates). The fingers 66, 67 are spaced apart from each other. Each of the fingers 66, 67 extends along the entire length of the spindle 54. A ramp 68 is provided between fingers 66, 67 on the surface of the spindle 54. The ramp 68 slopes from the free end 54b of the spindle 54 to the fixed end 54a of the spindle 54. The ramp is highest at the fixed end 54a of the spindle 54 and lowest at the free end 54b of the spindle 54. An elongated slot 69 is provided in the ramp 68. The slot extends from the fixed end 54a of the spindle 54 toward the free end 54b of the spindle 54 but does not reach the free end 54b of the spindle 54.

Between rib 64a and rib 64c the surface of the spindle 54 is curved. Between rib 64b and rib 64c the surface of the spindle 54 is curved. Between rib 64a and finger 67 the surface of the spindle 54 is curved. Between rib 64c and finger 66 the surface of the spindle 54 is curved.

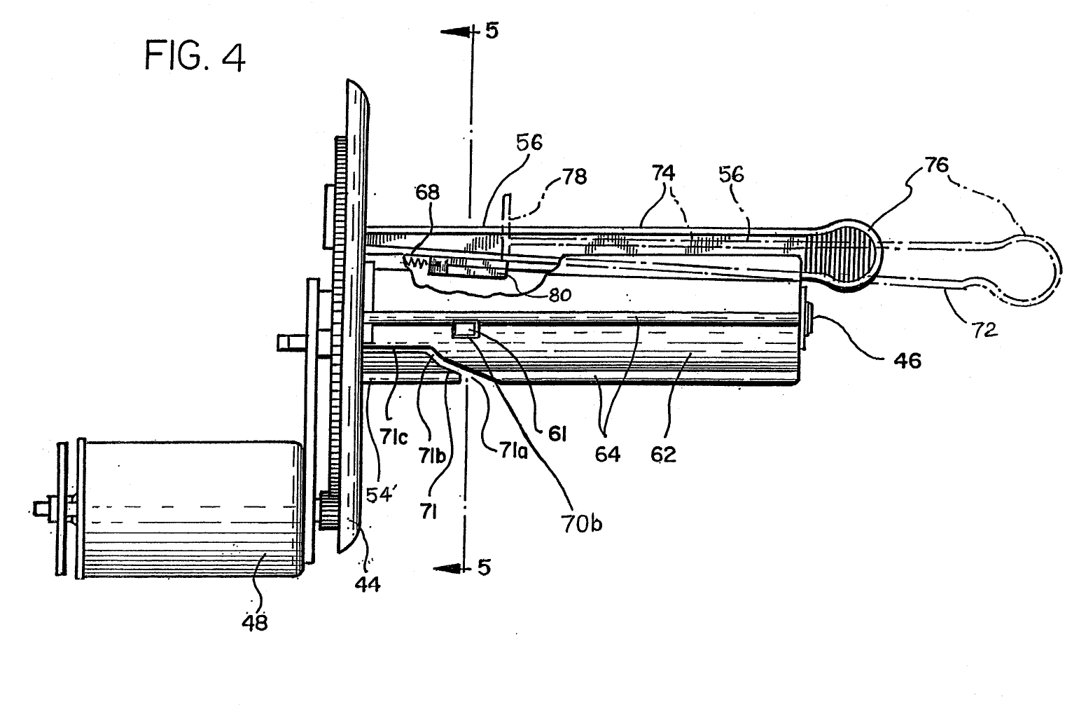

A first aperture 70a is provided through the cylindrical base 62 of the spindle 54. The first aperture 70a is positioned between rib 64a and finger 67. A second aperture 70b (see FIG. 4) is positioned between rib 64b and rib 64c. The apertures 70a, 70b are provided for reasons described herein.

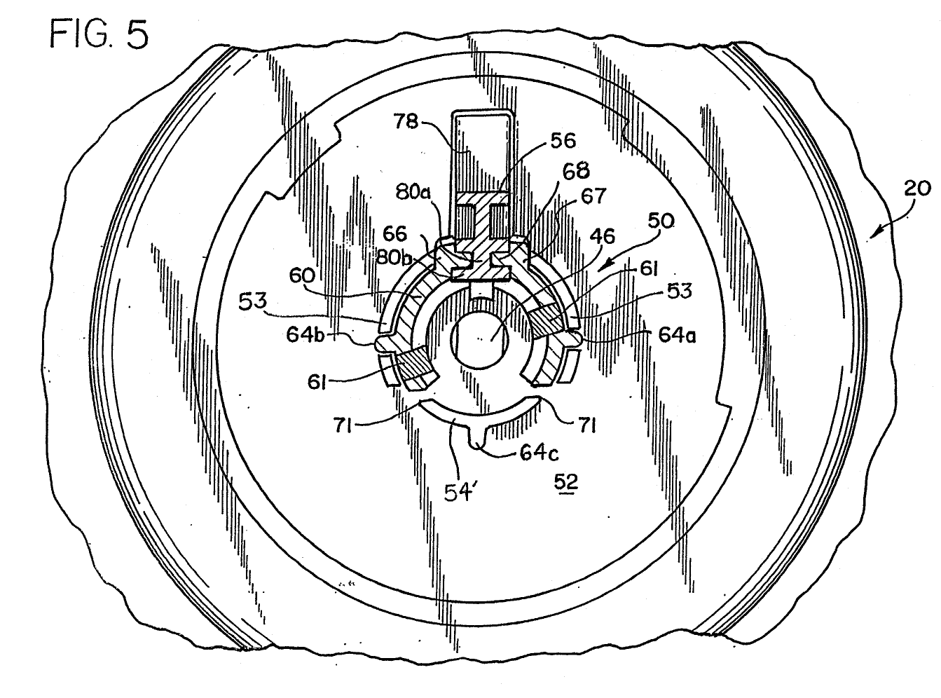

As shown in FIGS. 4 and 5, a slot 71 is provided through the base 62 of the spindle 54. As shown in FIG. 5, the slot 71 has a first portion 71a which is angled relative to the exterior surface of the base 62, a second portion 71b which is angled relative to the first portion 71a and a third portion 71c which is angled relative to the first portion 71a and the second portion 71b and is parallel to the exterior surface of the base 62. The slot 71 extends from the outer surface of the spindle 54 to the fixed end 54a of the spindle 54, resulting in geometry 54′ being taken away from the spindle 54. In the preferred embodiment, this geometry 54′ is fixed to the back plate 52 and may be integrated with the back plate 52.

As best shown in FIG. 3, the fin 56 includes an elongated body 73 which has a first end 73a and a second end 73b. The fin 56 also has an inner surface 72 and an outer surface 74. The inner surface 72 is angled. The angle of the inner surface 72 of the fin 56 corresponds to the angle of the ramp 68. The outer surface 74 of the fin 56 is straight (i.e. not ramped). Thus, the body 73 of the fin 56 is thickest near the second end 73b and thinnest near the first end 73a. A finger grip 76 is provided at the second end 73b of the body 73. The finger grip 76 is wider than the body 73 of the fin 56. The body 73 of the fin 56 has a height which is greater than the fingers 66, 67.

At the first end 73a of the body 73 of the fin 56, a tab 78 is provided which extends upwardly therefrom and perpendicularly thereto. An elongated T-shaped protrusion 80 extends from the inner surface 72 of the fin 56 proximate to the first end 73a. The protrusion 80 includes a stem 80a and a bar 80b, see FIG. 5. An aperture (not shown) is provided through the stem portion 80b for attachment of the spring 58 as will be described herein.

To begin assembly of the take-up spindle assembly 50, the fin 56 is attached to the spindle 54. To attach the fin 56 to the spindle 54, the tab 78 of the fin 56 is positioned proximate the fixed end 54a of the spindle 54 and the finger grip 76 of the fin 56 is positioned proximate the free end 54b of the spindle 54. Next, the inner surface 72 of the fin 56 is placed between the fingers 66, 67 of the spindle 54. The protrusion 80 is placed proximate to the fixed end 54a of the spindle 54 and the stem portion 80a of the protrusion 80 is placed within the slot 69 in the ramp 68 to attach the fin 56 to the spindle 54. The front end of the extension spring 58 is then passed through the aperture in the stem portion 80a of the protrusion 80 for attachment thereto.

The fin 56 is slid forward toward the free end 54b of the spindle 54. As the fin 56 is slid forward, the stem 80a slides within the slot 69 and the bar portion 80b of the locking protrusion 80 slides along a bottom surface of the ramp 68. The fin 56 is slid forward until the tab 78 is proximate the fixed end 54a of the spindle 54.

Next, the spindle 54 is slid over the arms 60 on the back plate 52. Curved walls 53 assist in properly aligning the spindle 54 with the back plate 52. As the spindle 54 is slid backward, toward the back plate 52, the arms 60 compress inwardly. When the ears 61 are aligned with the apertures 70a, 70b, the arms 60 expand outwardly such that the ears 61 enter into the respective apertures 70a, 70b to lock the spindle 54 and the back plate 52 together. When the spindle 54 is mounted on the back plate 52, the tab 78 of the fin 56 is aligned within the recess 63 in the back plate 52. The rear end of the extension spring 58 is passed through the aperture 65 and is attached to the back plate 52.

Finally, the back plate 52 is slid over the shaft 46. The take-up spindle assembly 50 and the back plate 52 are rotatable relative to the shaft 46.

Although, the spring 58 is shown and described as being mounted on the rear end through an aperture 65 and to the back plate 52 and on the front end through an aperture in the stem portion 80a of the protrusion 80, the spring 58 can be mounted to various points on the back plate 52 and the fin 56. For example, the rear end of the spring could be attached to the spindle 54 or the back plate 52 and the front end of the spring 58 could be attached to any portion of the fin 56.

As shown in FIG. 2 in use, the platen roller 32 is driven to pull the media 30 from the media supply spindle or from the source outside of the printer 22. The media 30 is pinched between the platen roller 32 and the printhead means. The printhead means prints images onto the label 36 as the label 36 passes thereunder. The backing 34 is bent around the peel mechanism 42 to peel the printed-on label 36 therefrom. Thereafter, the printed-on labels exit out the front of the printer 22.

As the spent backing 34 exits the peel mechanism 42, the take-up spindle 50 is being driven by the motor 48 through gearing, and at the same rate of rotation as that which the platen roller 32 is driven. As a result, the take-up and release mechanism 20 does not contribute to the peeling of the labels 36 from the backing 34.

Initially, the media 30 is threaded through the printer 22. The media 22 is fed from its supply, between the printhead means and the platen roller 32, through the peel mechanism 42, and the end of the media 30 is threaded through the slot 71 and around the take-up spindle assembly 50 to begin the roll of spent backing 34. The slot 71 allows the user to easily start winding the spent backing around the take-up spindle assembly 50. Because the diameter of the spindle 54 is small without any media 30 thereon, the backing 34 would have a tendency to unwrap when starting if not initially threaded through the slot 71. The slot 71, made up of angled surfaces 71a, 71b, 71c, puts a bend in the backing 34, which causes enough friction to start winding around the small diameter spindle 54 without unrolling. This presents a distinct advantage over prior art printers. Windings of the backing 34 are created as the backing 34 passes through the slot 71 over the rib 64b, over the finger 66, over the fin 56, over the finger 67, over the rib 64a, over the rib 64c, and back to the rib 64b. As best shown in FIG. 2, the path from rib 64b, over the fin 56, to rib 64a, to rib 64c and back to rib 64b defines the effective diameter of the take-up spindle assembly 50 around which the windings will be made.

When a roll of spent backing 34 has been collected on the take-up spindle assembly 50 it can then be removed from the media take-up and release mechanism 20. When a roll of spent backing 34 is desired to be removed from the media take-up and release mechanism 20, the user grasps the finger grip 76 and pulls the fin 56 forward, away from the back plate 52, as shown in FIG. 4. As the fin 56 is pulled forward, the spring 58 extends, the protrusion 80 slides along the bottom surface of the ramp 68, and the inner surface 72 slides along the top surface of the ramp 68. As the fin 56 is slid forward, the outer wall 74 of the fin 56 is brought closer to the spindle 54 thereby reducing the effective diameter of the take-up spindle assembly 50. As the effective diameter of the take-up spindle assembly 50 is reduced, pressure is removed from the inner windings of the spent rolled-up backing 34 and the inner-windings of the spent rolled-up backing 34 collapse. Because the effective diameter of the take-up spindle assembly 50 is reduced, additional space is present between the take-up spindle assembly 50 and the inner windings of the spent rolled-up backing 34, thus the sliding friction between the take-up spindle assembly 50 and the spent rolled-up backing 34 is reduced.

After fin 56 begins sliding along the ramp 68 and the friction is reduced between the backing 34 and the spindle assembly 50, the tab 78 engages the roll of spent backing 34 and assists in sliding the roll of spent backing 34 off of the spindle 54. The tab 78 eliminates the need for the user to get fingers behind the roll of spent backing 34 to pull the roll off of the spindle assembly 50.

After the roll of spent backing 34 has been pulled forward on the take-up spindle assembly 50, the user releases the finger grip 76 on the fin 56 and the spring 58 pulls the fin toward the back plate 52 to its original position. The roll of spent backing 34 will remain near the free end 54b of the spindle 54. Because the pressure between the inner winding of the spent backing 34 and the take-up spindle assembly 50 has been reduced, the user can then easily remove the roll of spent backing 34 from the take-up spindle assembly 50.

While the spindle 54 is described as being a molded plastic member, it is to be understood that the slot 71 formed in the spindle 54 can take other forms such as a bent wire form, bent sheet metal, an arrangement of pins, machined or fabricated part and the like. The important aspect of the slot 71 is that a bend is placed in the backing 34.

It is to be understood that it is not necessary for the slot 71 to extend from the outer surface of the spindle 54 to the fixed end 54a of the spindle 54. For example, if the slot 71 did not extend to the fixed end 54a of the spindle 54 the geometry 54′ would not be taken away form the spindle 54. If, for example, the slot 71 did not extend to the outer surface of the spindle 54 the backing would need to be threaded through the slot 71 rather than placing the backing in the slot. It is also to be understood that an aperture could be provided through the spindle 54 to function in a manner similar to the slot. For example, the leading end of the backing 34 could be placed within the aperture and would be retained within the interior of the spindle 54. As the spindle 54 is rotated the aperture would place a bend in the backing to create friction to begin the winding.

In addition, while the fin 56 is described as being a molded plastic member, it is to be understood that the fin 56 can take other forms such as a bent wire form, bent sheet metal, an arrangement of pins, machined or fabricated part and the like. The important aspect of the fin 56 is that it slides down the ramp 68 to lessen the perimeter around which the spent backing 34 is wound.

It is to be understood that the tab 78 is not necessary to make the present invention function.

It is also to be understood that the protrusion 80 need not be T-shaped. For example, rather then a T-shaped protrusion which engages the slot 69, a pin could extend from the inner surface 72 of the fin which would engage the slot 69. As the fin 56 is pulled forward the pin would slide within the slot 69. Alternatively, no protrusion could be provided which extends from the bottom wall 72 of the fin 56. Rather, the fin 56 could simply rest on the ramp 68, between the fingers 66, 67 with no protrusion present.

While a preferred embodiment of the present invention is shown and described, it is envisioned that those skilled in the art may devise various modifications of the present invention without departing from the spirit and scope of the appended claims.

The invention claimed is:

1. A media release mechanism comprising:
a spindle having a fixed end, a free end, and an exterior surface,
a ramp on the exterior surface of said spindle, wherein said ramp slopes from said free end to said fixed end, and
a fin for engagement with said ramp, said fin having an outer surface and an inner surface.

2. A media release mechanism as defined in claim 1, wherein said inner surface of said fin is angled relative to said outer surface of said fin.

3. A media release mechanism as defined in claim 1, further including a back plate, and wherein said fixed end of said spindle is mounted to said back plate.

4. A media release mechanism as defined in claim 3, further including arms extending from said back plate and said spindle is mounted to said back plate by engaging said arms with said spindle.

5. A media release mechanism as defined in claim 4, wherein said arms further include ears extending from said arms, wherein said spindle includes apertures through a wall of said spindle, and wherein said ears engage with said apertures.

6. A media release mechanism as defined in claim 3, further comprising a spring having a first end and a second end, wherein said first end of said spring is attached to said fin and a second end of said spring is attached to said back plate.

7. A media release mechanism as defined in claim 1, further comprising a protrusion extending from said inner surface of said fin.

8. A media release mechanism as defined in claim 7, wherein said ramp includes a slot and said protrusion of said fin is positioned within said slot.

9. A media release mechanism as defined in claim 7, wherein said protrusion is T-shaped.

10. A media release mechanism as defined in claim 1, wherein said spindle further includes fingers extending from said exterior surface of said spindle on either side of said ramp.

11. A media release mechanism as defined in claim 1, wherein said spindle includes a rib extending from the exterior surface of said spindle.

12. A media release mechanism as defined in claim 1, wherein said fin further includes a finger grip.

13. A media release mechanism as defined in claim 1, wherein said fin further includes a body and a tab extending outwardly from said body proximate said fixed end of said spindle.

14. A media release mechanism as defined in claim 2, wherein a ramp angle is formed by said ramp and said exterior surface of said spindle, wherein a fin angle is formed by said inner surface of said fin and said outer surface of said fin, and said ramp angle corresponds to said fin angle.

15. A media release mechanism as defined in claim 1, further including a slot in said spindle through which a media can be positioned and retained.

16. A printer comprising:
a housing;
printhead means mounted in said housing;
media delivery means mounted in said housing for delivering a media to said printhead;
a media take-up and release mechanism mounted in said housing; and
wherein said media take-up and release mechanism includes;
a spindle having a fixed end, a free end, and an exterior surface,
a ramp on the exterior surface of said spindle, wherein said ramp slopes from said free end to said fixed end, and
a fin for engagement with said ramp, said fin having an outer surface and an inner surface.

17. A printer as defined in claim 16, wherein, said inner surface of said fin is angled relative to said outer surface of said fin.

18. A printer as defined in claim 16, further including a back plate mounted in said housing and said media release mechanism is mounted to said back plate.

19. A printer as defined in claim 16, wherein said media release mechanism further includes a protrusion extending from said inner surface of said fin, said ramp includes a slot, and said protrusion of said fin is positioned with in said slot.

20. A printer as defined in claim 16, wherein said media release mechanism further includes fingers extending from said exterior surface of said spindle on either side of said ramp.

21. A method of collecting and releasing media from a spindle assembly including the steps of:
providing a spindle having a fixed end, a free end, and an exterior surface,
providing a ramp on the exterior surface of said spindle, wherein said ramp slopes outward from said free end to said fixed end,
providing a fin for engagement with said ramp, said fin having an outer surface and an inner surface,
winding said media around said spindle and said fin,
sliding said fin toward said free end of said spindle, and
removing said media from said spindle and said fin.

22. A method of collecting and releasing media from a spindle as defined in claim 21, wherein said inner surface of said fin is angled relative to said outer surface of said fin.

23. A method as defined in claim 21, further including the steps of:
providing a slot in said spindle;
threading said media through said slot prior to winding said media around said spindle and said fin.

24. A spindle having an exterior surface and a slot provided in said exterior surface, and wherein said slot receives a media to be wound around said exterior surface.

25. A spindle as defined in claim 21, wherein said slot includes a first portion, a second portion and a third portion, said first portion being angled relative to said exterior surface, said second portion being angled relative to said first portion, and said third portion parallel to said exterior surface.
